(19) United States
(12) Patent Application Publication
(10) Pub. No.: US 2013/0108282 A1
(43) Pub. Date: May 2, 2013

(54) IMAGE FORMING APPARATUS

(71) Applicant: OKI DATA CORPORATION, Tokyo (JP)

(72) Inventors: Masahiro SONODA, Tokyo (JP); Yoichi HAYAKAWA, Tokyo (JP)

(73) Assignee: OKI DATA CORPORATION, Tokyo (JP)

(21) Appl. No.: 13/661,379

(22) Filed: Oct. 26, 2012

(30) Foreign Application Priority Data
Oct. 28, 2011 (JP) 2011-237915

(51) Int. Cl. G03G 15/00; G03G 15/08

(52) U.S. Cl. 399/12; 399/27; 399/26

(57) ABSTRACT

An image forming apparatus includes a controller, an image bearing device with a first memory and one of a first developer material holding device, and a second developer material holding device that are detachably attached to the image bearing device. The first developer material holding device includes a second memory and the second developer material holding device does not includes the second memory. The controller makes a decision to determine whether a developer material holding device attached to the image bearing device has the second memory attached thereto. The controller manages one of the first developer material holding device and the second developer material holding device in accordance with the decision.

### BACKGROUND OF THE INVENTION

1. Field of the Invention

The present invention relates to an image forming apparatus to which replaceable components holding consumables therein are detachably attached.

2. Description of the Related Art

Image forming apparatuses such as copying machines, facsimile machines, and printers are widely used. For example, a printer uses replaceable components including a drum unit (image bearing unit) and a toner cartridge (developer holding unit), which are detachably mounted to the body of the printer. These replaceable components are available in various types depending on the applications. They incorporate replaceable components, for example, a drum as an image bearing body or toner as a developer material, and therefore have a so-called lifetime such as the number of times of usage or the cumulative amount of consumed toner. Therefore, these pieces of information about the replaceable components should be managed properly so as to avoid degradation of print quality, malfunctions, or trouble.

Japanese patent publication No. 2008-003259 discloses such replaceable components. A drum unit and a toner cartridge employ a memory tag that holds information about an individual drum unit or a toner cartridge. When a drum or toner cartridge is attached to a printer body, the printer reads the information from the memory tag to determine whether the drum or toner cartridge is acceptable to the printer. If the drum or toner cartridge is not acceptable to the printer, the printer informs the user that the attached replaceable component is not acceptable.

However, for example, the aforementioned conventional toner cartridge necessarily requires the memory tag to be mounted thereto. This leads to increased number of parts of the toner cartridge and hence increased manufacturing costs.

### SUMMARY OF THE INVENTION

The present invention was made to solve the aforementioned drawbacks.

An object of the invention is to provide an image forming apparatus in which a factory-installed toner cartridge has no memory tag attached thereto when the image forming apparatus is shipped out from the factory.

An image forming apparatus includes a controller, an image bearing device with a first memory and one of a first developer material holding device, and a second developer material holding device that are detachably attached to the image bearing device. The first developer material holding device includes a second memory attached thereto and the second developer material holding device does not include the second memory attached thereto. The first memory holds first management information used for managing the second developer material holding device and type information indicative of whether a developer material holding device attached to the image bearing device is acceptable to the image bearing device. The second memory holds second management information used for managing the first developer material holding device. The controller is configured to make a decision to determine whether a developer material holding device attached to the image bearing device has the second memory attached thereto. The controller manages one of the first developer material holding device and the second developer material holding device in accordance with the decision.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limiting the present invention, and wherein:

FIG. 1 is a side view illustrating the outline of the interior structure of an image forming apparatus according to a first embodiment;

FIGS. 2A and 2B are block diagrams illustrating the control of the first embodiment;

FIGS. 3A and 3B illustrate the structure of data held in a memory according to the first embodiment;

FIG. 4 is a flowchart illustrating the operation of the first embodiment; and

FIG. 5 is a flowchart illustrating the operation of a second embodiment.

### DETAILED DESCRIPTION OF THE INVENTION

The factory-installed toner cartridge according to the present invention covers not only a toner cartridge installed into an image forming apparatus before shipment but also a toner cartridge attached to a drum unit separate from an image forming apparatus.

### First Embodiment

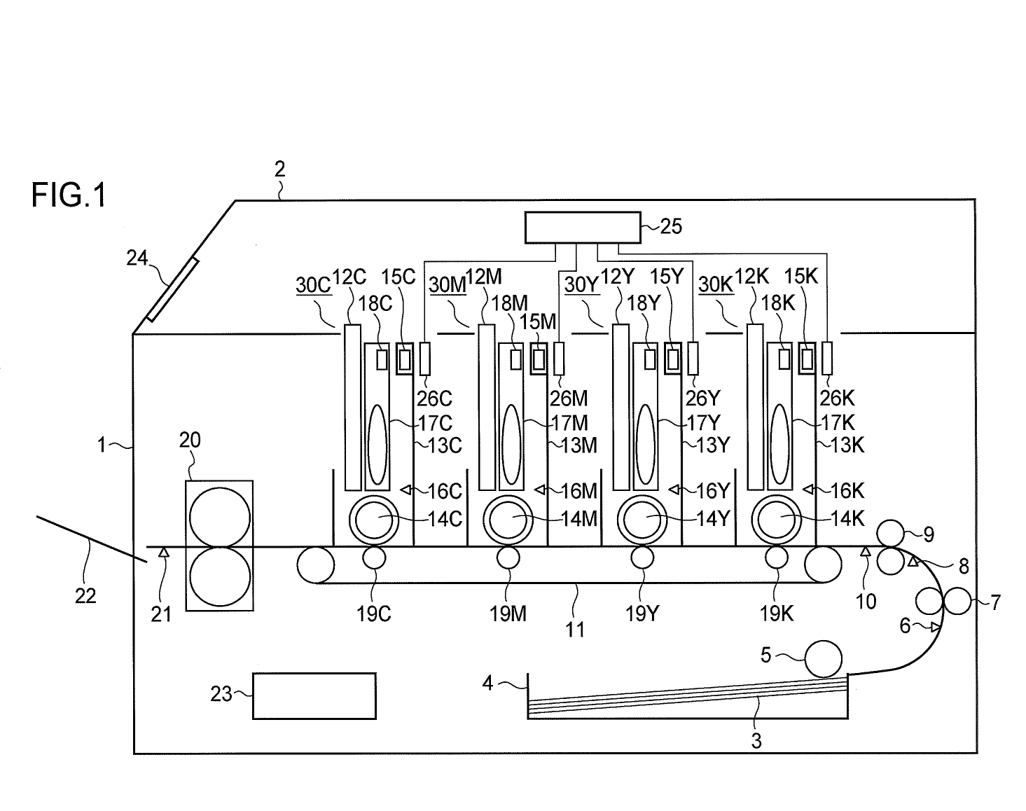

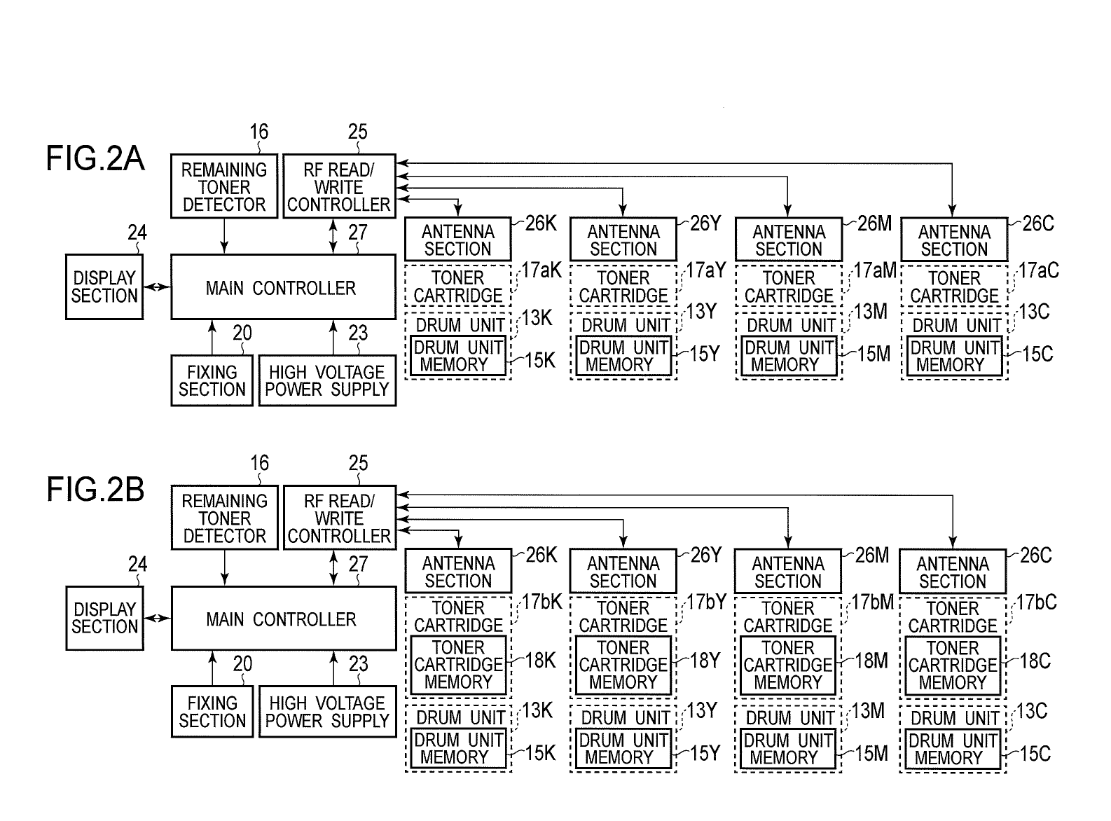

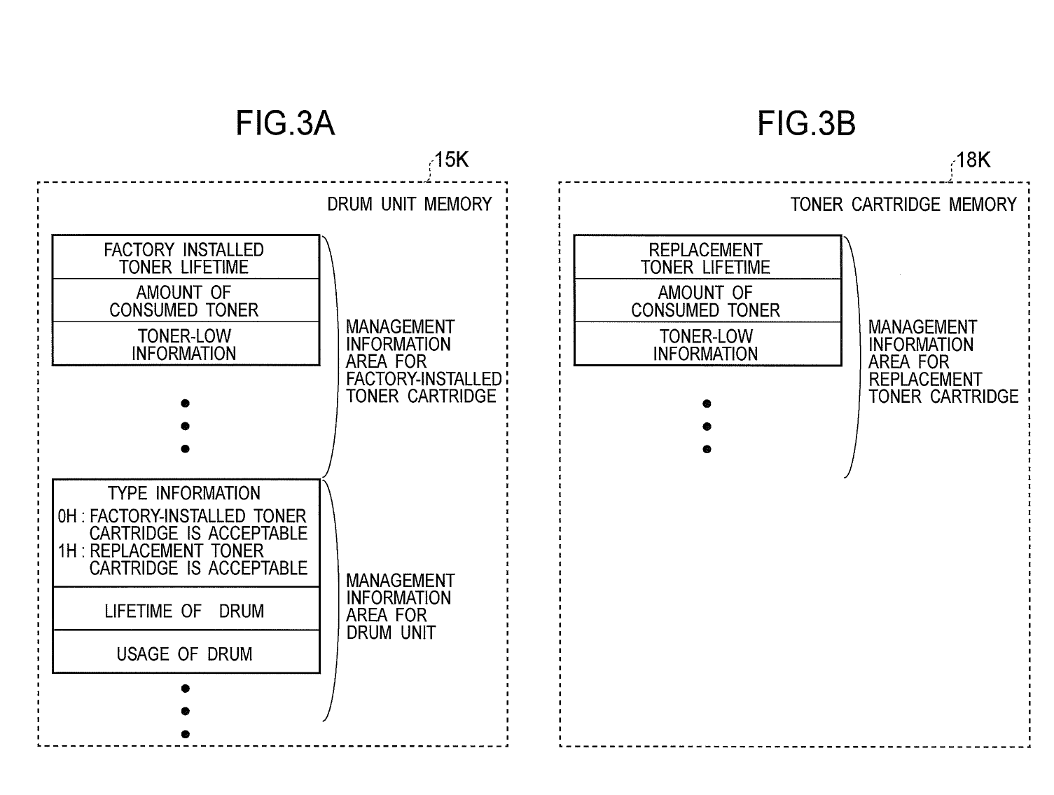

FIG. 1 is a side view illustrating the outline of the interior structure of an image forming apparatus according to a first embodiment. By way of example, the image forming apparatus takes the form of a color printer that prints a color image on a recording medium 3. The present invention may also be applied to a monochrome printer. The printer includes a body and a top cover 2 that can be opened and closed relative to the body 1. FIG. 2 is a block diagram illustrating the control of the first embodiment. FIG. 3 illustrates the data structure of a memory according to the first embodiment.

A medium cassette 4 holds a stack of the print medium 3 therein, and is disposed at the bottom portion of the body 1. A feed roller 5 is disposed in contact with the top sheet of the stack of the recording medium 3 in the vicinity of the entrance of a transport path, and feeds the recording medium 3 from the medium cassette 4 into the transport path on a sheet-by-sheet basis. A first registry roller 7 and a second registry roller 9 are disposed along the transport path, and are configured to transport the recording medium 3 fed by the feeding roller 5 from the medium cassette 4.

A medium sensor 6 is disposed immediately upstream of the first registry roller 7, and detects the recording medium 3 when the recording medium 3 arrives at the medium sensor 6. A medium sensor 8 is disposed immediately upstream of the second registry roller 9, and detects the recording medium 3 when the recording medium arrives at the medium sensor 8. A medium sensor 10 is disposed immediately downstream of the second registry roller 9, and detects the recording medium 3 when the recording medium 3 arrives at the medium sensor 10. The recording medium 3 arrives at a transfer point of a black image forming section 13K, defined between a photoconductive drum 14K and a transfer roller 19K, a predetermined period of time after the medium sensor 10 detects the recording medium 3. A transport belt 11 transports the recording medium 3 thereon from upstream to downstream through the respective image forming sections 30K, 30Y, 30M, and 30C. The transport belt 11 extends in the image forming apparatus from the front end to the rear end of the image forming apparatus.

The printer includes four image forming sections 30K, 30Y, 30M, and 30C for printing black, yellow, magenta, and cyan images, respectively. The image forming sections 30K, 30Y, 30M, and 30C are aligned in this order from upstream to downstream along the direction in which the recording medium 3 is transported. Each of the image forming sections 30K, 30Y, 30M, and 30C may be substantially identical; for simplicity only the operation of the image forming section 30K for forming black images will be described, it being understood that the other image forming sections 30Y, 30M, and 30C may work in a similar fashion.

An LED head 12K is connected to the body 1 of the printer, and illuminates the charged surface of a corresponding photoconductive drum 14K in accordance with print data to form an electrostatic latent image. The LED head 12K is supported on the top cover 2 by means of a holder. When the top cover 2 is closed relative to the body 1, the LED head 12K moves to a position close to the surface of the photoconductive drum 14K, so that the LED head 12K is ready to illuminate the charged surface of the photoconductive drum 14K in accordance with the print data.

A drum unit 13K includes the photoconductive drum 14K as an image bearing body, a drum unit memory 15K as a first memory section, and a remaining toner detector 16K as a remaining toner detecting section. The photoconductive drum 14K is a rotatable body on which an electrostatic latent image may be formed in accordance with the print data by selectively dissipating the charges on the photoconductive drum 14K. The drum unit memory 15K includes an RFID tag chip incorporating a non-volatile memory therein and a printed circuit board having an antenna pattern formed thereon, and is configured to communicate with an RF read/write controller 25, which will be described later in detail, by wireless communication. The remaining toner detector 16K detects the amount of toner remaining in the drum unit 13K into which the toner is supplied from the toner cartridge 17K. A main controller 27, which will be described later, determines the remaining toner based on the detection result of the remaining toner detector 16K.

The toner cartridge 17K holds black toner therein, and is detachably attached to the top of the corresponding drum unit 13K. Once the toner cartridge 17K has been attached to the drum unit 13K, the toner can be supplied into the drum unit 13K. The factory-installed toner cartridge and drum unit 13K are attached to the body 1 of the printer before shipment from the factory. Also, replacement toner cartridges that hold toners of the corresponding colors may be packed together with the printer before shipment from the factory.

The drum unit 13K has a drum unit memory 15K attached thereto. When the printer is shipped out from the factory, the toner cartridge (as a second developer holding device) that has been attached to the printer has no memory attached thereto. The replacement toner cartridge (as a second developer holding device) has a toner cartridge memory (as a second memory) 18K attached thereto. FIG. 1 shows the replacement toner cartridge 17K with the toner cartridge memory 18K attached thereto.

The toner cartridge memory 18K includes an RFID tag chip having a built-in non-volatile memory and a printed trace that functions as an antenna pattern, and is configured to communicate with the RF read/write controller 25 (FIGS. 2A and 2B) by wireless communication. The toner cartridge 17K and drum unit 13K constitute an image developing portion for black images. The toner cartridge 17K holds black toner, and drum unit 13K holds a photoconductive drum 14K. The toner cartridge 17K is detachably attached to the drum unit 13K, which is also detachably attached to the body 1 of the printer.

A transfer roller 19K faces the photoconductive drum 14K. A high voltage is applied across the photoconductive drum 14K and transfer roller 14K to develop an electric field thereacross, so that the toner image formed on the photoconductive drum 19K is transferred onto the recording medium 3 by Coulomb force.

A fixing section 20 fixes the toner image on the recording medium 3 by heat and pressure. The fixing section 20 includes fixing rollers that hold the recording medium therebetween in a sandwiched relation, and heat the toner image on the recording medium 3, thereby fixing the toner image into a permanent image. A medium sensor 21 is located immediately downstream of the fixing section 20, and detects the recording medium 3 when the recording medium 3 leaves the fixing section 20. A stacker 22 is located at the end of the transport path of the recording medium 3, and the recording medium 3 is discharged onto the stacker 22 after fixing. A high voltage power supply 23 outputs high voltages to the photoconductive drums 14K, 14Y, 14M, and 14C and transfer rollers 19K, 19Y, 19M, and 19C.

The medium sensors 6, 8, 10 and 21 are connected to the main controller 27 of the printer via cables. Actuators (not shown) mechanically drive the feeding roller 5, first registry roller 7, second registry roller 9, photoconductive drum 14K, transfer roller 19K, and fixing rollers, thereby transporting the recording medium 3 from upstream to downstream in the transport path. A display section 24 includes a printed circuit board with a liquid crystal display panel and switches mounted thereon. The display section 24 is connected to the main controller 27 via cables, displays the status of the printer to the user, and receives commands from the user. The liquid crystal display is capable of displaying characters in a 24-by-2 matrix.

The RF read/write controller 25 is connected to a power supply and the main controller 27 via cables so that the RF read/write controller 25 communicates with the main controller 27 of the printer via the cables. The RF read/write controller 25 is also connected to the antenna sections 26K, 26Y, 26M, and 26C via cables, so that the RF read/write controller 25 can communicate by wireless communication with the drum unit memories 15K, 15Y, 15M, and 15C mounted on the drum units (as image bearing units) 13K, 13Y, 13M, and 13C, the toner cartridge memories 18K, 18Y, 18M, and 18C mounted on the toner cartridges 17K, 17Y, 17M, and 17C, thereby controlling data-read and data-write operations between these memory tags and the main controller 27 of the printer. It is to be noted that the antenna, sections 26K, 26Y, 26M, and 26C are disposed to face the drum unit memories 15K, 15Y, 15M, and 15C and toner cartridge memories 18K, 18Y, 18M, and 18C for multiple read and write operations.

### {Drum Unit Memory and Toner Cartridge Memory}

FIGS. 2A and 2B are block diagrams illustrating the control system of the first embodiment. FIG. 2A illustrates the control system when the printer has the factory-installed toner cartridges (as a second developer material holding device) 17aK, 17aY, 17aM, and 17aC attached thereto. FIG. 2B illustrates the control system when the replacement cartridges (as a first developer material holding device) 17bK, 17bY, 17bM, and 17bC have been attached to the printer by the user. The main controller 27 controls the operations of the printer, executing a variety of processes in the printer under the control of overall control programs. The main controller 27 also functions as a printing controller for controlling a printing operation.

The main controller 27 is connected to the fixing section 20, high voltage power supply 23, display section 24, RF read/write controller 25, and remaining toner detectors 16K, 16Y, 16M, and 16C. The medium sensors 6, 8, 10, and 21 and respective actuators (not shown) are also connected to the main controller 27, and are controlled by the main controller 27.

As described above, the present invention uses two types of toner cartridges: factory-installed toner cartridges 17aK, 17aY, 17aM, and 17aC attached before shipment from the factory and replacement toner cartridges 17bK, 17bY, 17bM, and 17bC for placement by the user.

Referring to FIG. 2A, the factory-installed toner cartridges 17aK, 17aY, 17aM, and 17aC are not equipped with the toner cartridge memories 18K, 18Y, 18M, and 18C. Therefore, the main controller 27 communicates with the drum unit memories 15K, 15Y, 15M, and 15C via the antenna sections 26K, 26Y, 26M, and 26C, respectively, and the RF read/write controller 25, thereby reading information from the drum unit memories 15K, 15Y, 15M, and 15C and writing information into the drum unit memories 15K, 15Y, 15M, and 15C.

Referring to FIG. 2B, the replacement toner cartridges 17bK, 17bY, 17bM, and 17bC are equipped with the toner cartridge memories 18K, 18Y, 18M, and 18C, respectively. The main controller 27 communicates with the drum unit memories 15K, 15Y, 15M, and 15C and the toner cartridge memories 18K, 18Y, 18M, and 18C via the antenna sections 26K, 26Y, 26M, and 26C, respectively, and the RF read/write controller 25, thereby reading information into the drum unit memories 15K, 15Y, 15M, and 15C and 18K, 18Y, 18M, and 18C, and writing information from the drum unit memories 15K, 15Y, 15M, and 15C and the toner cartridge memories 18K, 18Y, 18M, and 18C.

FIGS. 3A and 3B illustrate examples of the information, held in the toner cartridge memory 18K and drum unit memory 15K, according to the first embodiment. FIG. 3A illustrates an example of information stored in the drum unit memories 15K, 15Y, 15M, and 15C, which hold information about the drum unit 13K and information about the toner stored in the factory-installed toner cartridge 17aK. FIG. 3B illustrates an example of information stored in the toner cartridge memory 18K, which holds information about a consumable item, e.g., toner.

Referring to FIG. 3A, the drum unit memory 15K includes two memory areas: a management information area or toner cartridge area for factory-installed toner cartridge that stores management information (as first management information) about the factory-installed toner cartridge 17aK and a management information area or drum unit area for a drum unit that stores drum unit management information about the drum unit 13K. The toner cartridge area stores the factory-installed toner lifetime, and a cumulative amount of consumed toner, and toner-low information. The drum unit area stores the type information, i.e., 1H or 0H, lifetime of drum, and cumulative usage of drum. The factory-installed toner lifetime indicates the amount of toner held in a new, unused factory-installed toner cartridge. When the cumulative amount of consumed toner approaches the factory-installed toner lifetime, there will be only a small amount of toner left before the factory-installed toner cartridge is completely exhausted of toner. The toner-low information is one bit of information that indicates whether the toner in the toner cartridge has been exhausted. The toner-low information “0” indicates that the toner cartridge still holds a significant amount of toner therein so that printing can be carried on. The toner-low information “1” indicates that the toner cartridge is almost exhausted of toner and should be replaced soon with a new, unused toner cartridge.

Referring to FIG. 3B, the toner cartridge memory 18K stores the management information (as second management information) about the replacement toner cartridge, including the replacement toner lifetime, the cumulative amount of consumed toner, and toner-low information. The toner-low information is one bit of information that indicates whether the toner in the toner cartridge has been exhausted. The toner-low information “0” indicates that the toner cartridge still holds a significant amount of toner therein so that printing can be carried on. The toner-low information “1” indicates that the toner cartridge is almost exhausted of toner and should be replaced soon with a new, unused toner cartridge.

The management information stored in the drum unit memory 15K and toner cartridge memory 18K will be described in more detail. The management information of the factory-installed toner cartridge held in the drum unit memory 15K is used for managing the toner in the factory-installed toner cartridge. The drum unit management information held in the drum unit memory 15K is used for managing the usage of the photoconductive drum 14K.

The factory-installed toner lifetime indicates the lifetime of toner in the factory-installed toner cartridge 17aK. The factory-installed toner lifetime is expressed in terms of the number of printable pages of the recording medium 3, e.g., 2,000 pages. The cumulative amount of consumed toner is expressed in terms of the cumulative number of pages of the printed recording medium 3, provided that the total area occupied by the dots printed at a resolution of 1200 dpi on each page is equivalent to an area of 5% of a total printable area of A4 size recording medium 3. Thus, if the total area occupied by the dots printed on each page is equivalent to an area of 12% of a total printable area of A4 size recording medium 3, then the number of counted pages is interpreted as being 2.4 pages. Once the cumulative amount of consumed toner reaches a reference value (e.g., 2,000 pages), it is determined that the factory-installed toner cartridge 17aK has reached the end of its lifetime. The toner-low information of the factory-installed toner cartridge is detected by the remaining toner detector 16K. When the remaining toner detector 16K detects the toner-low condition, the main controller sets the one bit of information from “0” to “1.”

### {Toner Detector}

The operation of the remaining toner detector 16K will be described.

The toner or developer material is held in the factory-installed toner cartridge 17aK and the replacement toner cartridge 17bK. When the factory-installed toner cartridge 17aK or replacement toner cartridge 17bK is attached to the drum unit 13K, the factory-installed toner cartridge 17aK or replacement toner cartridge 17bK supplies the toner into the drum unit 13K. The remaining toner detector 16K is disposed in the drum unit 13K, and detects the presence of the toner in the drum unit 13K. A reflector and an agitating bar in the drum unit 13K operate in an interlocked manner so that the remaining toner detector 16K reads the light reflected by the reflector by means of an optical sensor. Therefore, if the drum unit 13K holds a sufficient amount of toner therein, the agitating bar rotates slowly due to a relatively large load exerted by the toner, so that the remaining toner detector 16K receives the light for a relatively longer time. Conversely, if the drum unit 13K does not hold a sufficient amount of toner therein, the agitating bar rotates fast due to a relatively small load exerted by the toner, so that the remaining toner detector 16K receives the light from the reflector for a relatively shorter time. The amount of toner remaining in the drum unit 13K may be detected in accordance with the amount of time. If the amount of time is larger, the main controller 27 determines that the factory-installed toner cartridge 17aK or replacement toner cartridge 17bK has not a significant amount of toner remaining therein.

As described above, the drum unit management information includes the type information, lifetime of drum, and cumulative usage of drum.

The type information “0H” indicates that the factory-installed toner cartridge 17a is accepted, and the type information “1H” indicates that the replacement toner cartridge is accepted. The lifetime of drum expresses the lifetime of the photoconductive drum in terms of the number of pages of A4 size recording medium 3, e.g., 5,000 pages. The cumulative usage of the photoconductive drum is expressed in terms of number of printed A4 size pages, which is cumulatively counted every time printing is performed by the color printer. If the accumulated number of printed pages reaches the lifetime of drum, it is determined that the photoconductive drum has reached the end of its lifetime.

As described above, the management information stored in the toner cartridge memory 18K is used for managing the consumable item of the replacement toner cartridge, and includes the replacement toner lifetime, the cumulative amount of consumed toner, and toner-low information. The replacement toner lifetime expresses the lifetime of the replacement toner cartridge 17b in terms of the number of pages of the A4 size recording medium 3 that can be printed, e.g., 7,000 pages.

Just as the cumulative amount of consumed toner of the factory-installed toner cartridge, the cumulative amount of consumed toner of the replacement toner cartridge is expressed in terms of the number of pages of printed recording medium 3, provided that the total area occupied by the dots printed at a resolution of 1,200 dpi on each page is equivalent to an area of 5% of a total printable area of A4 size recording medium 3.

For example, if the total area occupied by the dots printed on each page is equivalent to an area of 12% of a total printable area of A4 size recording medium 3, then the number of counted pages is interpreted as being 2.4 pages. The replacement toner lifetime is a maximum number of pages that can be printed. Once the cumulative amount of consumed toner reaches the maximum value (e.g., 7,000 pages), it is determined that the replacement toner cartridge 17bK has reached the end of its lifetime. Just as in the factory-installed toner cartridge, the toner-low condition is detected by the remaining toner detector 16K. When the remaining toner detector 16K detects the toner-low condition, the main controller sets the one bit of information from “0” to “1.”

### {Operation of Printer}

The operation of the printer will be described. When the color printer has received a print command from a host apparatus such as a personal computer, the main controller 27 executes the overall control programs stored in the printer, thereby controlling the respective sections of the printer. The actuators including motors are energized to drive the feeding roller 5, first registry roller 7, and second registry roller 9 to rotate in directions in which the recording medium 3 is transported. The feeding roller 5 rotates to feed the sheet of the recording medium 3 from the medium cassette 4. The recording medium 3 is then transported by the first registry roller 7 and second registry roller 9 to the black image forming section 30K.

While the recording medium 3 is being transported, the recording medium 3 is detected by the medium sensor 6 immediately upstream of the first registry roller 7, then by the medium sensor 8 immediately upstream of the second registry roller 9, and finally by the medium server 10. Once the medium sensor 10 detects the recording medium 3, the electrophotographic printing process begins. Initially, the high voltage power supply 23 is driven to apply high voltages to the photoconductive drum 14K of the drum unit 13K in accordance with predetermined printing conditions, thereby charging the surface of the photoconductive drum 14K to a predetermined potential. The LED head 12K illuminates the charged surface of the photoconductive drum 14K in accordance with the print data received from the host apparatus to form an electrostatic latent image on the photoconductive drum 14K.

The transport belt 11, photoconductive drum 14K, and transfer roller 19K are driven so that the recording medium 3 is transported from upstream to downstream along the transport path. When the photoconductive drum 14K is rotating, the toner is supplied to the electrostatic latent image by means of Coulomb force, thereby forming a toner image on the photoconductive drum 14K.

The transfer roller 19 receives a high voltage from the high voltage supply 23, and transfers the toner image from the photoconductive drum 14K onto the recording medium 3. If the print data is for color printing, then the printing process is performed by the yellow, magenta, and cyan image forming sections 30Y, 30M, and 30C just as in the black image forming section 30K, thereby transferring images of corresponding colors in registration on the recording medium 3 to form a full color image.

The recording medium 3 having the toner image thereon is then transported to the fixing section 20 where the toner image is fixed by heat and pressure. The heat rollers have heat sources, e.g., halogen lamps, disposed therein. The temperature of the heat rollers is detected by a temperature sensor, e.g., a thermistor. The temperature of the heat rollers is controlled to a preferred temperature value based on the detected temperature. The recording medium 3 then leaves the fixing section 20, and passes the medium sensor 21 before being discharged onto the stacker.

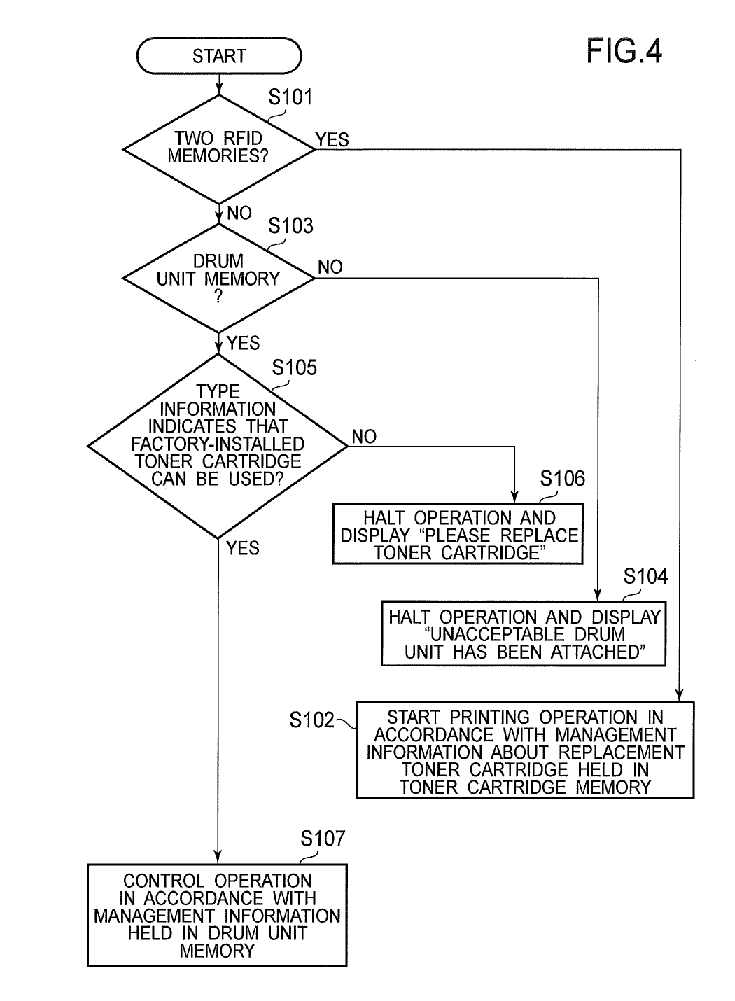

FIG. 4 is a flowchart illustrating the operation of the first embodiment. The main controller 27 performs the steps in the flowchart under the control of a control program stored in a memory of the printer.

Each of the LED heads 12K, 12Y, 12M, and 12C may be substantially identical; for simplicity only the operation of the LED head 12K for forming black images will be described, it being understood that the other LED heads 12Y, 12M, and 12C may work in a similar fashion. Likewise, only the operation of the drum unit 13K, photoconductive drum 14K, drum unit memory 15K, remaining toner detector 16K, factory-installed toner cartridge 17aK, replacement toner cartridge 17bK, toner cartridge memory 18K, transfer roller 19K, antenna section 26K, for forming black images will be described.

When the printer is turned on or the top cover 2 is closed shortly after the toner cartridge 17K is replaced or attached to the printer, the main controller 27 causes the RF read/write controller 25 to initiate its operation. The RF read/write controller 25 starts to communicate with the drum unit memory 15K and toner cartridge memory 18K by wireless communication via the antenna section 26K. The RF read/write controller 25 reads the management information from the drum unit memory 15K and toner cartridge memory 18K. The drum unit memory 15K and toner cartridge memory 18K have information different from each other, so that a single antenna section 26K is able to read the management information from the drum unit memory 15 and/or the toner cartridge memory 18K. The main controller 27 makes a decision to determine whether the RF read/write controller 25 has read two items of management information (S101).

If the RF read/write controller 25 has read two items of information, i.e., from the drum unit memory and toner cartridge memory, and the respective items of information coincide with those held in the body 1, the main controller 27 determines that the drum unit 13K and the replacement toner cartridge 17bK have been attached, and starts a printing operation in accordance with the management information about the replacement toner cartridge held in the toner cartridge memory 18K (S102).

Though not shown in FIG. 4, if the RF read/write controller 25 has read two items of information, i.e., from the drum unit memory and toner cartridge memory, and the respective items of information do not coincide with those held in the body 1 of the printer, i.e., if the management information in the drum unit memory 15K differs from the information held in the body 1, the main controller 27 causes the display section 24 to display an error message to, for example, the operator. The error message may be, for example, “An unacceptable drum unit has been attached,” and then halts the operation. If the management information in the toner cartridge memory 18K differs from the information held in the body 1, the main controller 27 causes the display section 24 to display an error message to, for example, the operator. The error message may be, for example, “An unacceptable toner cartridge has been attached,” and then halts the operation.

If the RF read/write controller 25 has read only one item of management information, the main controller 27 checks the content of the management information to determine whether the management information is held in the drum unit memory 15K or the toner cartridge memory 18K (S103). If the management information is held in the toner cartridge memory 18K, the drum unit 13K attached to the color printer may not have the drum unit memory 15K. Thus, the main controller 27 determines that the drum unit 13 in the color printer is not acceptable. The main controller 27 then causes the display section 24 to display an error message to, for example, the operator. The error message may be, for example, “An unacceptable drum unit has been attached,” and then halts the operation (S104).

If the management information is held in the drum unit memory 15K, the main controller 27 determines that it is highly probable that a toner cartridge without a toner cartridge memory is attached to the color printer. Thus, the main controller 27 reads the type information from the drum unit memory 15K, and then makes a decision to determine whether the toner cartridge 17aK can be used with the drum unit 13K that is actually attached to the color printer (S105).

If the type information is “1H,” the factory-installed toner cartridge 17aK that has been attached cannot be used with the drum unit 13K actually attached to the color printer. Therefore, the main controller 27 causes the display section 24 to display an error message, for example, “Please replace the toner cartridge,” and then halts the operation (S106).

If the type information is “0H,” the factory-installed toner cartridge 17aK that has been attached can be used with the drum unit 13 actually attached to the color printer. Therefore, the main controller 27 uses the management information for the factory-installed toner cartridge 17aK held in the drum unit memory 15K to control printing operations, (S107). Thereafter, the factory-installed cartridge 17aK is managed and controlled until the remaining toner detector 16K detects the toner-low condition or the number of printed pages of the recording medium 3 reaches the factory-installed toner lifetime (e.g., 2,000 pages).

As described above, before the printer is shipped from the factory, the information about the factory-installed toner cartridge is stored in the drum unit memory of the drum unit attached to the printer. Thus, when the printer operates, the toner cartridge attached to the printer can be managed and controlled based on the information stored in the drum unit memory of the drum unit. As a result, the factory-installed toner cartridge attached to the printer before the printer is shipped from the factory can be managed without a memory attached thereto. This reduces the number Of parts of the factory-installed toner cartridge—hence reductions in the manufacturing cost of the factory-installed toner cartridge.

Moreover, the information about the factory-installed toner cartridge can be stored into the drum unit memory attached to the drum unit together with the information about the drum unit. This implies that the information need not be stored into the factory-installed toner cartridge and drum unit by separate procedures but can be stored at a time.

### Second Embodiment

A second embodiment has the same configuration as the first embodiment.

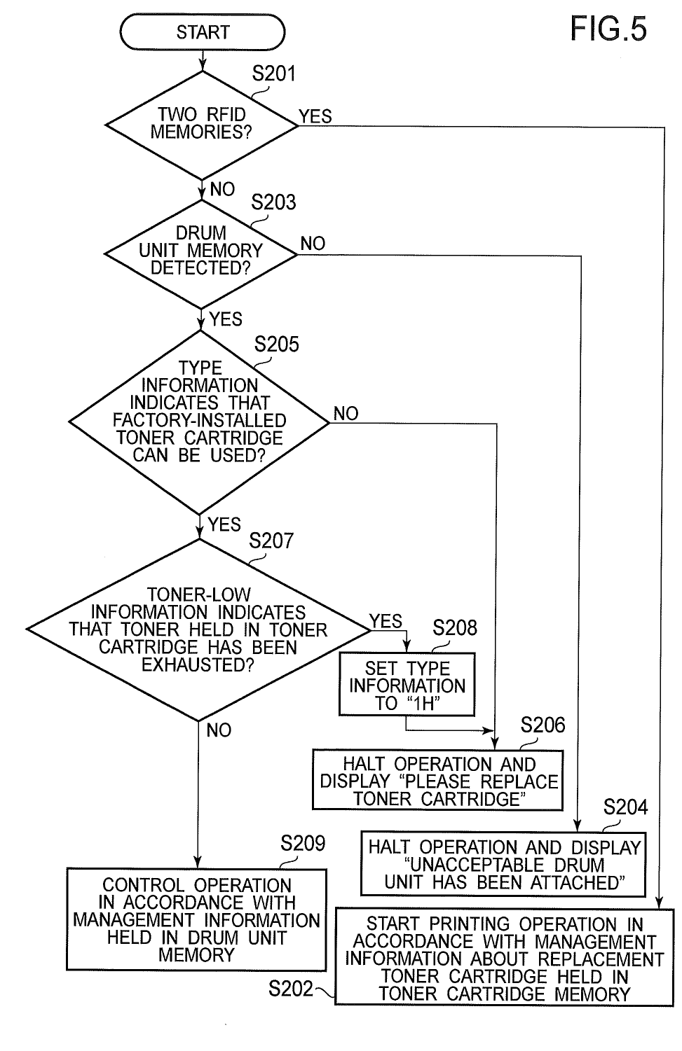

FIG. 5 is a flowchart illustrating the operation of the second embodiment. The second embodiment will be described with reference to FIG. 5. The operation of the following sections is controlled by a main controller 27 under the control of a control program stored in a memory of a color printer.

Each of the image forming sections 30K, 30Y, 30M, and 30C maybe substantially identical; for simplicity only the operation of the image forming section 30K for forming black images will be described, it being understood that the other image forming sections 30Y, 30M, and 30C may work in a similar fashion.

The printer may be turned on immediately after a toner cartridge has been attached or replaced or after a cover 2 has been opened and then closed. The main controller 27 controls an RF read/write controller 25, thereby initiating wireless communication with a drum unit memory 15K attached to the drum unit 13K and a toner cartridge memory 18K attached to the toner cartridge 17bK to read management information from the drum unit memory 15K and the toner cartridge memory 18K. The drum unit memory 15K and toner cartridge memory 18 have management information different from each other. Thus, the management information can be read from either one of the drum unit memory 15K and toner cartridge memory 18K or both of the drum unit memory 15K and toner cartridge memory 18K via a single antenna section 26K. The main controller 27 makes a decision to determine whether two items of management information have been read (S201).

If two items of management information have been read and coincide to the information held in the body 1, the main controller 27 determines that the drum unit 13K with the drum unit memory 15K attached thereto and the replacement toner cartridge 17bK with the toner cartridge memory 18K attached thereto have been mounted on the printer. The main controller 27 then controls the printing operations based on the management information held in the toner cartridge memory 18K attached to the replacement toner cartridge (S202).

Though not shown in FIG. 5, if the RF read/write controller 25 has read two items of information, i.e., from both the drum unit memory 15K and toner cartridge memory 18K, and the respective items of information do not coincide with those held in the body 1 of the printer, i.e., if the management information in the drum unit memory 15K differs from the item of information in the body 1 of the printer stored before shipment, the main controller 27 causes a display section 24 to display an error message to, for example, the operator. The error message may be, for example, “An unacceptable drum unit has been attached”, and then halts the operation. If the management information in the toner cartridge memory 18K differs from the information in the body 1 of the printer stored before shipment, the main controller 27 causes the display section 24 to display an error message to, for example, the operator. The error message may be, for example, “An unacceptable replacement toner cartridge has been attached”, and then halts the operation.

If the RF read/write controller 25 has read only one item of management information, the main controller 27 checks the content of the management information to determine whether the management information is held in the drum unit memory 15K or the toner cartridge memory 18K (S203). If the memory is the toner cartridge memory 18K, the drum unit 13K attached to the printer may not have a memory attached thereto. Thus, the main controller 27 determines that the drum unit 13K in the printer is not acceptable. The main controller 27 then causes the display section 24 to display an error message to, for example, the operator. The error message may be, for example, “An unacceptable drum unit has been attached,” and then halts the operation (S204).

If the memory is the drum unit memory 15K, the main controller 27 determines that it is highly probable that the factory-installed toner cartridge 17aK, which has not a memory, has been attached to the printer. Thus, the main controller 27 reads the type information from the drum unit memory 15, and then makes a decision to determine whether the factory-installed toner cartridge 17aK can be used with the drum unit 13K that is actually attached to the printer (S205).

If the type information is “1H,” the replacement cartridge 17bK cannot be used with the drum unit 13K actually attached to the printer. Therefore, the main controller 27 causes the display section 24 to display an error message, for example, “Please replace the toner cartridge,” and then halts the operation (S206).

If the type information is “0H,” the factory-installed cartridge 17aK can be used with the drum unit 13K actually attached to the printer. Therefore, the main controller 27 reads the toner-low information from the drum unit memory 15K, and makes a decision to determine whether the toner-low information has been set to “1” (S207).

If the toner-low information has been set to “1,” it is determined that the factory-installed toner cartridge 17aK has been used until the “toner-low” is reached. Thus, the main controller 27 drives the RF read/write controller 25 to set the type information held in the drum memory 15K to “1H” and the replacement toner cartridge 17bK is now accepted (S208). The main controller 27 then causes the display section 24 to display a message, for example, “Please replace the toner cartridge,” and then halts the operation (S206).

If the toner-low information has not been set to “0,” it is determined that the factory-installed toner cartridge 17aK has not reached the toner-low condition yet. Thus, the drum unit 13K still accepts the factory-installed toner cartridge 17aK, and the main controller 27 uses the management information held in the drum unit memory 15K to control printing operations (S209).

As described above, the second embodiment provides the same advantages as the first embodiment. Moreover, when the factory-installed toner cartridge is exhausted of toner, the type information indicative of the factory-installed toner cartridge is automatically replaced by the type information indicative of the replacement toner cartridge. This configuration can reduce time and effort for the operator to input the information about the replacement toner cartridge.

The first and second embodiments have been described with reference to a tandem color image forming apparatus, e.g., printer. The invention is not limited to this. The invention may also be applicable to a multi function peripherals including a copying machine and a facsimile machine. Further, the invention is applicable not only to a color image forming apparatus but also to a monochrome image forming apparatus.

The invention being thus described, it will be obvious that the same may be varied in many ways. Such variations are not to be regarded as a departure from the scope of the invention, and all such modifications as would be obvious to one skilled in the art are intended to be included within the scope of the following claims.

What is claimed is:

1. An image forming apparatus, comprising:
an image bearing device with a first memory;
one of a first developer material holding device and a second developer material holding device that are detachably attached to the image bearing device, the first developer material holding device including a second memory attached thereto and the second developer material holding device not including the second memory attached thereto,
wherein the first memory holds first management information used for managing the second developer material holding device and type information indicative of whether a developer material holding device attached to the image bearing device is acceptable to the image bearing device,
wherein the second memory holds second management information used for managing the first developer material holding device; and
a controller configured to make a decision to determine whether the developer material holding device attached to the image bearing device has the second memory attached thereto;
wherein the controller manages one of the first developer material holding device and the second developer material holding device in accordance with the decision.

2. The image forming apparatus according to claim 1, wherein if the controller determines that the developer material holding device attached to the image bearing device has the second memory, the controller manages the developer material holding device attached to the image bearing device in accordance with the second management information held in the second memory.

3. The image forming apparatus according to claim 1, wherein if the controller determines that the developer material holding device attached to the image bearing device has not the second memory, the controller manages the developer material holding device attached to the image bearing device in accordance with the first management information held in the first memory.

4. The image forming apparatus according to claim 3, wherein if the type information indicates that the first developer material holding device is acceptable, the controller manages the developer material holding device attached to the image bearing device in accordance with the first management information.

5. The image forming apparatus according to claim 3, wherein if the type information indicates that the second developer material holding device is acceptable, the controller manages the developer material holding device attached to the image bearing device in accordance with the second management information.

6. The image forming apparatus according to claim 1, wherein the first management information includes information indicative of an amount of consumed developer material held in the second developer material holding device.

7. The image forming apparatus according to claim 1, wherein the first management information includes information indicative of an initial amount of the developer material held in the second developer material holding device.

8. The image forming apparatus according to claim 1, wherein the first management information includes developer-low information indicative of whether the developer material held in the second developer material holding device has been substantially exhausted.

9. The image forming apparatus according to claim 8, wherein if the developer-low information indicates that the toner in the toner cartridge has been exhausted, the controller prohibits the second developer material holding device from being used.

10. The image forming apparatus according to claim 9, wherein the controller sets the type information in the first memory to indicate that the second developer material holding device is acceptable.

11. The image forming apparatus according to claim 1 further comprising a communicating section that directly communicates with the first memory and the second memory.
